(19) United States
(12) Patent Application Publication
(10) Pub. No.: US 2002/0024608 A1
(43) Pub. Date: Feb. 28, 2002

(54) Information processing apparatus and recording medium

(75) Inventors: Satoshi Ejima, Tokyo (JP); Akihiko Hamamura, Chiba-shi (JP)

Correspondence Address: OLIFF & BERRIDGE, PLC, P.O. Box 19928, Alexandria, VA, 22320, US

(73) Assignee: Nikon Corporation

(21) Appl. No.: 09/939,814

(22) Filed: Aug. 28, 2001

Related U.S. Application Data
(63) Continuation of application No. 08/965,200, filed on Nov. 6, 1997.

(30) Foreign Application Priority Data
May 13, 1997 (JP) 09-122009

(51) Int. Cl. H04N 5/222

(52) U.S. Cl. 348/333.05

(57) ABSTRACT

In an information processing apparatus, when a plurality of images are selected by a selection device, a display controller causes reduced images to be displayed so that the reduced images corresponding to the images are arranged on the screen in a designated order in accordance with the order in which the images were selected by the selection device. The reduced images of the selected images are displayed arranged on the screen in the order of selection.

### RELATED PROVISIONAL APPLICATION

This nonprovisional application claims the benefit of Provisional Application No. 60/052,217, filed Jul. 11, 1997.

### INCORPORATION BY REFERENCE

The disclosure of the following priority application is herein incorporated by reference: Japanese Patent Application No. 9-122009, filed May 13, 1997.

### BACKGROUND OF THE INVENTION

1. Field of Invention

The present invention relates to an information processing apparatus and a recording medium, and relates for example to an information processing apparatus and recording medium that enables a plurality of information items to be displayed, in the order of selection, by partitioning a screen.

2. Description of Related Art

In recent years, use of electronic cameras which shoot the image of an object using a CCD or the like and which record the image in an internal memory, removable memory cards or the like after converting the image into digital data is becoming common in place of cameras which use film. An image which is photographed with such an electronic camera may be reproduced immediately and displayed on the screen of an LCD, CRT or the like without going through the processes of development and printing required by a conventional camera.

Furthermore, apparatus exist which display a plurality of photographed images in the order photographed by partitioning the screen into four parts, or which produce a so-called slide show wherein an arbitrary plurality of images are stipulated and those images are reproduced at a designated time interval in the order in which the images were recorded.

However, there is no apparatus such that when an arbitrary plurality of images are selected, the screen is partitioned into small screens in accordance with the number of selected images and these images are displayed on the small screens so as to be lined up on the screen in the order the images were selected.

In addition, there is no apparatus such that the plurality of selected images is displayed at a designated time interval in the order of selection.

### SUMMARY OF THE INVENTION

In consideration of the foregoing, it is an object of the present invention to provide an apparatus such that when an arbitrary plurality of images are selected, compressed images of the selected images are displayed on each small screen so as to be lined up on the screen in the order of selection.

One embodiment of an information processing apparatus of the present invention comprises an imaging means for imaging designated images, a memory means for storing the images that have been imaged by the imaging means, a selection means for selecting arbitrary images from among the images stored in the memory means, a reduction means for reducing the images selected by the selection means, and a display control means for displaying on a designated screen reduced images that are the images reduced by the reduction means. When a plurality of images are selected by the selection means, the display control means displays the reduced images so that they are lined up on the screen in the order in which the images were selected by the selection means.

In addition, it is possible for the apparatus to further comprise a partition means for partitioning the designated screen into a plurality of small screens in accordance with the number of images selected by the selection means. The display control means then displays the reduced images on the small screens.

In addition, it is possible for the apparatus to further comprise a reduced image selection means for selecting arbitrary images out of the reduced images so that the display control means displays on the screen the images of the selected reduced images prior to reduction.

In addition, it is possible for the apparatus to further comprise a line drawing input means for inputting line drawings. The memory means stores the line drawings that have been input by the line drawing input means and, when the line drawings are made to correspond to the images selected by the selection means, the reduction means reduces the line drawings stored in the memory means and the display control means displays the reduced line drawings along with the reduced images.

In addition, it is possible that when the line drawings stored in the memory means have been selected by the selection means, the reduction means reduces the line drawings and the display control means causes line drawings reduced by the reduction means to be displayed.

In addition, it is possible for the apparatus to further comprise a display means for displaying the images and the reduced images. The display means may also display the line drawings and the reduced line drawings.

The recording medium of the present invention is of the type on which is recorded a computer-readable control program used by an information processing apparatus so that when a plurality of stored images are selected, the reduced images are displayed in a designated order on a screen in correspondence with the order in which the images were selected.

In the information processing apparatus of the present invention, when a plurality of images are selected by the selection means, the display control means causes the reduced images to be displayed on the screen in a designated order in accordance with the order in which the images were selected by the selection means.

### BRIEF DESCRIPTION OF THE DRAWINGS

The invention will be described in conjunction with the following drawings in which like reference numerals designate like elements and wherein:

FIG. 1 is a frontal perspective view of an electronic camera to which the present invention is applied;

FIG. 2 is a rear perspective view of the electronic camera, viewed from the back with the LCD cover open;

FIG. 3 is a rear perspective view of the electronic camera, viewed from the back with the LCD cover closed;

FIG. 4 shows an example of the inside of the electronic camera;

FIGS. 5(A)-5(C) illustrate operation of the LCD switch and the LCD cover;

FIG. 6 is a block diagram describing an internal electrical structure of the electronic camera;

FIG. 7 is a drawing illustrating an example of a thinning process;

FIG. 8 is a drawing illustrating another example of a thinning process;

FIG. 9 shows an example of a display screen displayed in the LCD of the electronic camera;

FIG. 10 is a flowchart explaining the sequence for displaying a plurality of selected images on small screens that are partitions of the screen;

FIG. 11 shows the LCD and operation key area when a plurality of thumbnail images are selected on a screen showing a table;

FIG. 12 shows the LCD and operating key area when four selected images are displayed on small screens arranged in the order of selection;

FIG. 13 shows the LCD and operation key area when thumbnail images on a subsequent page of the screen showing a table are also selected;

FIG. 14 shows the LCD and operation key area when seven selected images are displayed on small screens arranged in the order of selection;

FIG. 15 is a flowchart explaining the sequence for displaying a plurality of selected images on the LCD without partitioning the screen; and

FIGS. 16(A)-16(D) show the LCD and operation key area when the selected images are displayed on the screen for a designated time interval and in the order of selection.

### DETAILED DESCRIPTION OF PREFERRED EMBODIMENTS

A preferred embodiment of the present invention is described hereafter, with reference to the drawings.

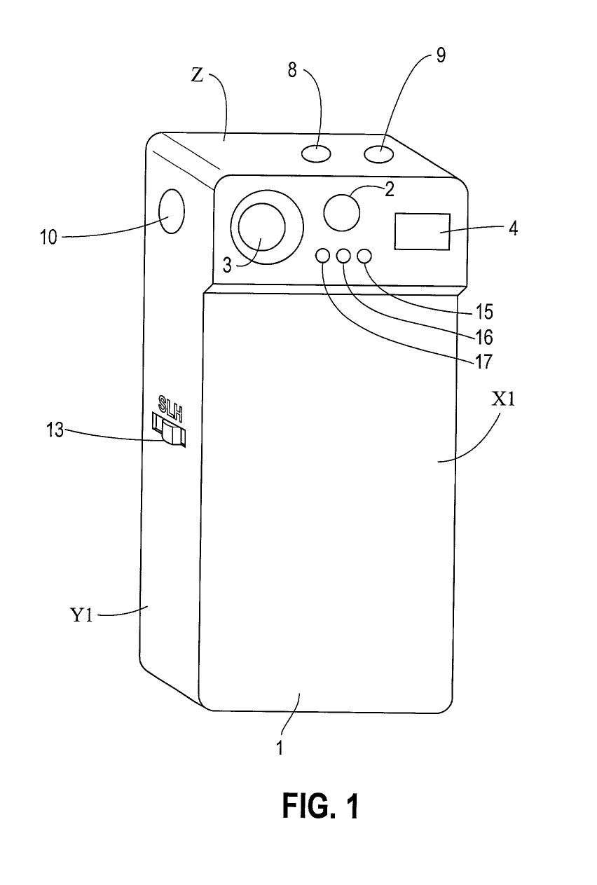

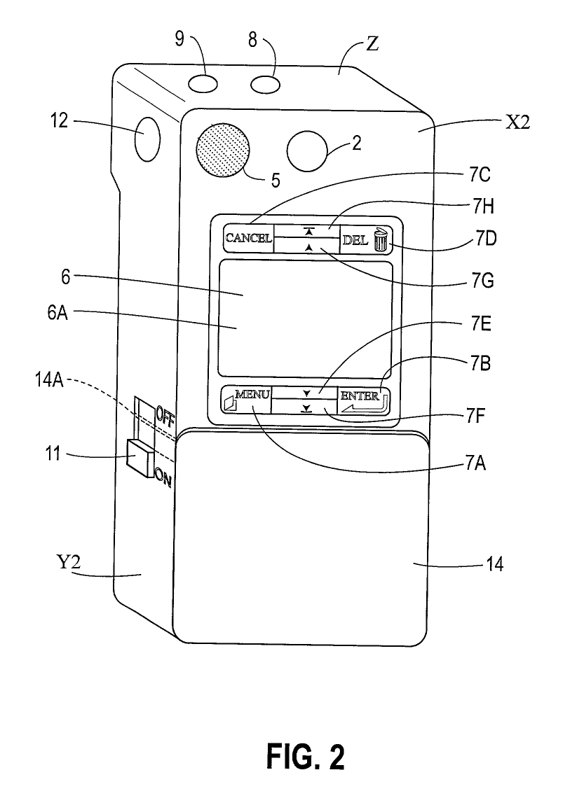

FIG. 1 and FIG. 2 are perspective views showing structural examples of an electronic camera to which the present invention is applied. In the electronic camera of the present embodiment, the surface facing the object is defined as face X1 and the surface facing the user is defined as face X2. On the top edge section of face X1, a viewfinder 2 which is used to verify the shooting range of the object, a shooting lens 3 which takes in the optical image of the object, and a light emitting unit (strobe) 4 which emits light to illuminate the object are provided.

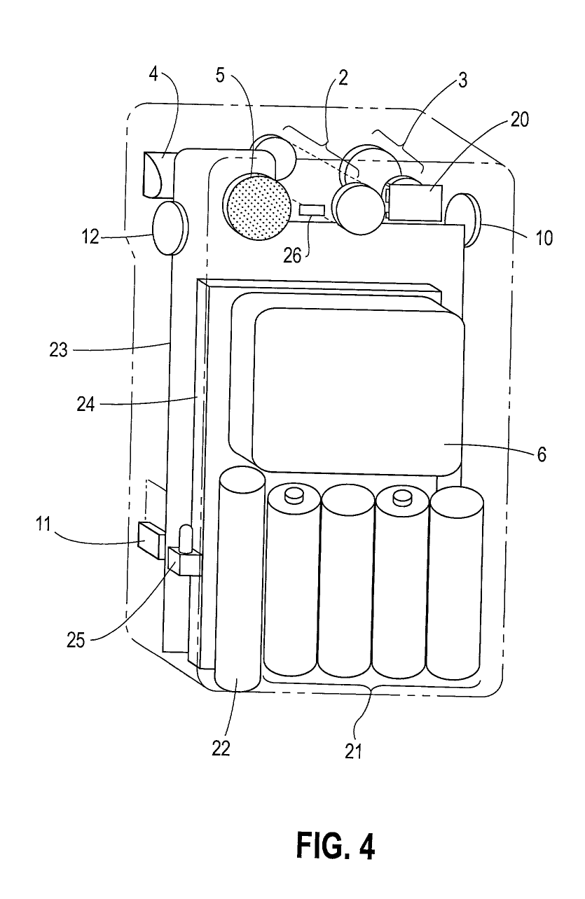

Moreover, on face X1, a photometry element 16 measures light during the operation of a red-eye reduction LED 15 which reduces red eye by emitting light before causing the light emitting unit 4 to emit light. A CCD 20 (FIG. 4) is prevented from photographing when light emitting unit 4 is emitting light. Also on face X1 is a colorimetry device 17 which measures color during the time when operation of CCD 20 is stopped.

On the top edge section of face X2 (a position corresponding to the top section of face X1 where the viewfinder 2, the shooting lens 3 and the light emitting unit 4 are located), the viewfinder 2 and a speaker 5 are provided. The speaker 5 outputs the sound recorded in the electronic camera 1. Moreover, the LCD 6 and the operation key area 7 are formed on face X2 vertically below the viewfinder 2 and the speaker 5. On the surface of the LCD 6, a touch tablet 6A is arranged which outputs position data corresponding to the position designated by a touching operation of a pen type pointing device, which will be explained later.

An image formed inside the touch tablet 6A being displayed on the LCD 6 is visible to the user through the touch tablet 6A, which is made of transparent material such as glass or resin.

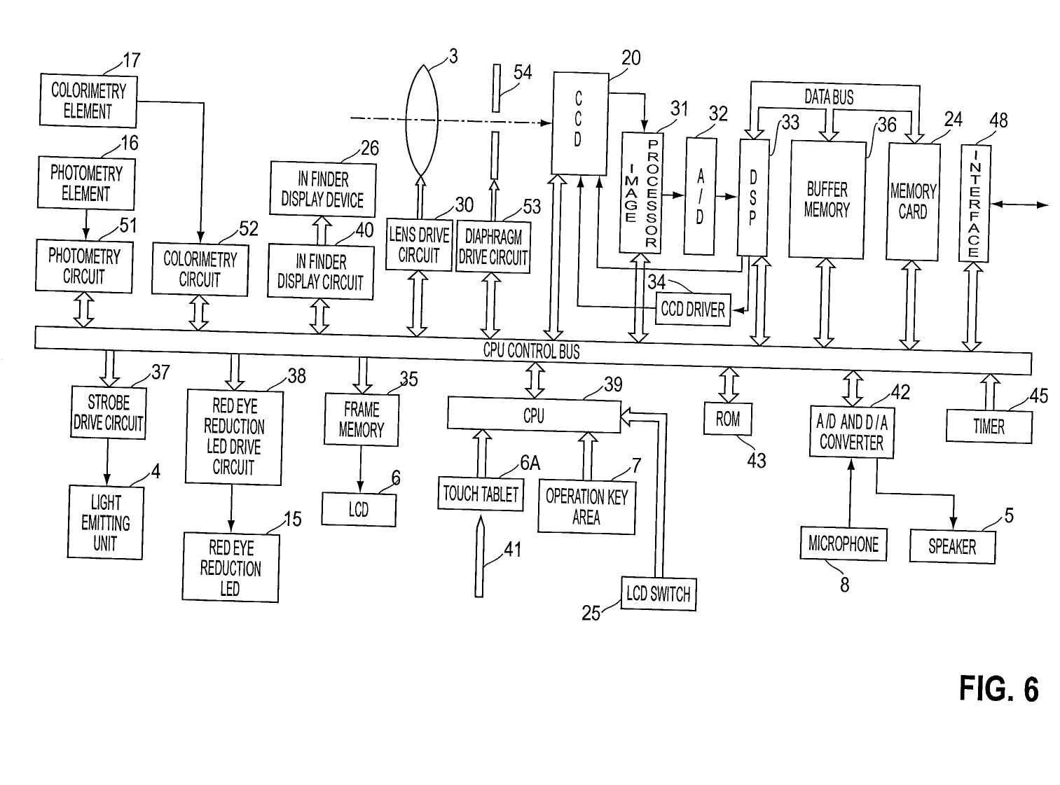

The operation key area 7 contains the keys to be operated in reproducing and displaying recording data on the LCD 6 and in supplying the user's input to the CPU (central processing unit) 39 (FIG. 6). Operation of the menu key 7A of the operation key area 7 displays the menu screen on the LCD 6. Operation of the execution key 7B reproduces the recording information selected by the user. Operation of the cancel key 7C interrupts the process of reproducing recorded information. The delete key 7D deletes recorded information. The scroll keys 7E through 7H scroll the screen vertically when the recorded information is displayed as a table on the LCD 6.

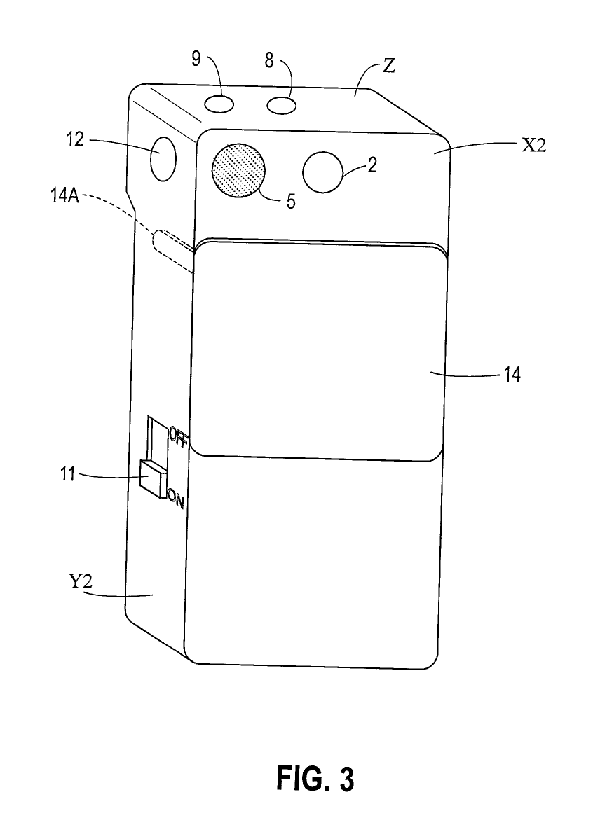

The LCD cover 14 slides freely and is provided on face X2 to protect the LCD 6 when it is not in use. When moved upward in the vertical direction, the LCD cover 14 covers the LCD 6 and the touch tablet 6A as shown in FIG. 3. When the LCD cover 14 is moved downward in the vertical direction, the LCD 6 and the touch tablet 6A are exposed and the power switch 11 (described later) on face Y2 is switched to the “ON” position by the arm member 14A of the LCD cover 14.

A microphone 8 to gather sound and an earphone jack 9 to which an earphone (not shown) is connected are provided on face Z which comprises the top surface of the electronic camera 1.

A release switch 10 which is operated in shooting an object and a continuous shooting mode switch 13 which is operated in switching the continuous shooting mode during shooting are provided on the left side surface (face Y1). The release switch 10 and the continuous shooting mode switch 13 are arranged vertically below the viewfinder 2, shooting lens 3 and the light emitting unit 4.

A recording switch 12 to be operated in recording sound and a power switch 11 are provided on face Y2 (right surface) opposite face Y1. Like the release switch 10 and the continuous shooting mode switch 13 described above, the recording switch 12 and the power switch 11 are arranged vertically below the viewfinder 2, the shooting lens 3 and the light emitting unit 4. Moreover, the recording switch 12 and the release switch 10 are located at virtually the same height so that the user does not feel any difference when the camera is held by either hand.

The height of the recording switch 12 and the release switch 10 may be intentionally changed so that the user will not accidentally press one switch provided in the opposite side surface when the other switch is pressed and the user's fingers hold the other side surface to offset the moment created by the pressing of the other switch.

The continuous shooting mode switch 13 is used to switch between shooting one frame or several frames of the object with a press of the release switch 10.

For example, if the indicator of the continuous shooting mode switch 13 is pointed to the “S” position and the release switch 10 is pressed, the camera shoots only one frame. Moreover, if the indicator of the continuous shooting mode switch 13 is pointed to the “L” position and the release switch 10 is pressed, the camera shoots eight frames per second as long as the release switch 10 is pressed (namely, the low speed continuous shooting mode is enabled). Furthermore, if the indicator of the continuous shooting mode switch 13 is pointed to the “H” position and the release switch 10 is pressed, the camera shoots 30 frames per second as long as the release switch 10 is pressed (namely, the high speed continuous shooting mode is enabled).

Next, internal structure of the electronic camera 1 will be described. FIG. 4 is a perspective view of an example of an internal structure of the electronic camera shown in FIGS. 1 and 2. The CCD 20 is provided at the rear of the shooting lens 3 and photoelectrically converts the optical (light) image of the object imaged through the shooting lens 3 to electric (image) signals.

The display device 26 in the viewfinder 2 is arranged inside the vision screen of the viewfinder 2 and displays setting conditions and the like of various functions.

Batteries (for example, four AA dry cell batteries) 21 are placed below the LCD 6 and the electric power stored in the batteries 21 is supplied to each part of the electronic camera 1. Moreover, a capacitor 22 is provided below the LCD 6 and next to the batteries 21 to accumulate an electrical charge which is used to cause the light emitting unit 4 to emit light.

Various control circuits are formed on the circuit board 23 to control each part of the electronic camera 1. Moreover, a removable memory card 24 is provided between the circuit board 23 and both the LCD 6 and the batteries 21. The memory card 24 stores various information which is to be input into the electronic camera 1.

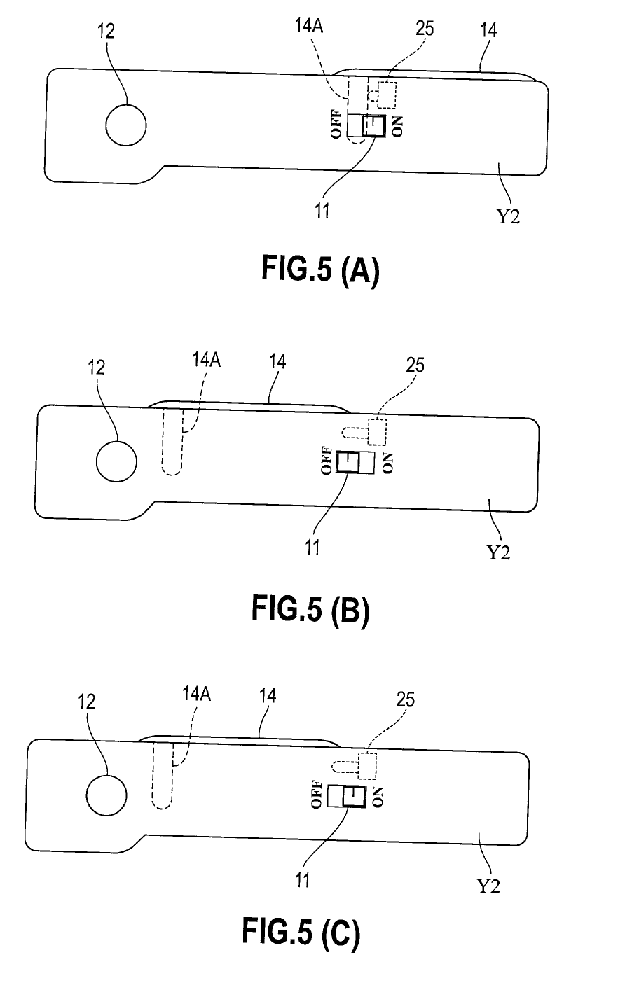

Moreover, an LCD switch 25 is arranged adjacent to the power switch 11. The LCD switch 25 is switched to the “ON” position with the power switch 11 by the arm member 14A of the LCD cover 14 when the LCD cover 14 is moved vertically downward as shown in FIG. 5(A).

Moreover, if the LCD cover 14 moves upward vertically, the power switch 11 is operated by the user independent of the LCD switch 25. For example, if the LCD cover 14 is closed and the electronic camera 1 is not being used, the power switch 11 and the LCD switch 25 are in the “OFF” position as shown in FIG. 5(B). In this mode, if the user switches the power switch 11 to the “ON” position as shown in FIG. 5(C), the power switch 11 is in the “ON” position but the LCD switch 25 continues to be in the “OFF” position. On the other hand, when the power switch 11 and the LCD switch 25 are in the “OFF” position as shown in FIG. 5(B), if the LCD cover 14 is opened, the power switch 11 and the LCD switch 25 switch to the “ON” position as shown in FIG. 5(A). Then, when the LCD cover 14 is closed, only the LCD switch 25 switches to the “OFF” position as shown in FIG. 5(C).

In the present embodiment, the memory card 24 is removable, but a memory in which various information can be recorded may be provided on the circuit board 23. Moreover, various information recorded in the memory (memory card 24) may be output to an external personal computer and the like through an interface 48.

Next, an internal electric structure of the electronic camera 1 of the present embodiment will be described with reference to the block diagram of FIG. 6. The CCD 20, which includes a plurality of pixels, photoelectrically converts the optical image imaged on each pixel into image signals (electric signals). The digital signal processor (hereafter referred to as DSP) 33, in addition to supplying the CCD horizontal driving pulse to the CCD 20, supplies the CCD vertical driving pulse to the CCD 20 by controlling the CCD driving circuit 34.

The image processing unit 31 is controlled by the CPU 39 to sample the image signals which are photoelectrically converted by the CCD 20 with a predetermined timing and to amplify the sampled signals to a predetermined level. The CPU 39 controls each part according to the control program which is stored in the ROM 43. The analog/digital conversion circuit (hereafter the A/D conversion circuit) 32 digitizes the image signals which are sampled by the image processing unit 31 and supplies them to the DSP 33.

The DSP 33 controls the buffer memory 36 and the data bus connected to the memory card 24 to temporarily store the image data which is supplied from the A/D conversion circuit 32 in the buffer memory 36. The DSP then reads the image data stored in the buffer memory 36 and records the image data in the memory card 24.

Moreover, the DSP 33 instructs the frame memory 35 to store the image data which is supplied by the A/D conversion circuit 32, displays the image data on the LCD 6, reads the shooting image data from the memory card 24, decompresses the shooting data, stores the decompressed image data in the frame memory 35 and displays the decompressed image data on the LCD 6.

Moreover, when the electronic camera 1 is started, the DSP 33 operates the CCD 20 repeatedly by adjusting the exposure time (exposure value) until the exposure level of the CCD 20 reaches an appropriate level. Alternatively, the DSP 33 may be made to operate the photometry circuit 51 first, then compute the initial value of the exposure time of the CCD 20 corresponding to a light level which is detected by the photometry element 16. By using this alternate method, adjustment of the exposure time for the CCD 20 may be achieved in a short time.

In addition, the DSP 33 executes timing management for data input/output during recording on the memory card 24 and stores decompressed image data in the buffer memory 36.

The buffer memory 36 is used to compensate for the difference between the data input/output speed of the memory card 24 and the processing speed of the CPU 39 and the DSP 33.

The microphone 8 inputs sound information (gathers sound) and supplies the sound information to the A/D and D/A conversion circuit 42.

The A/D and D/A conversion circuit 42 converts the analog signals to digital signals, supplies the digital signals to the CPU 39, changes the sound data supplied by the CPU 39 to analog signals, and outputs the analog sound signals to the speaker 5.

The photometry element 16 measures the light level of the object and its surrounding area and outputs the measurement results to the photometry circuit 51. The photometry circuit 51 executes a predetermined process on the analog signals which comprise the measurement results supplied from the photometry element 16, converts them to digital signals and outputs the digital signals to the CPU 39.

The colorimetry element 17 measures the color temperature of the object and its surrounding area and outputs the measurement results to the colorimetry circuit 52. The colorimetry circuit 52 executes a predetermined process on the analog signals which comprise the color measurement results supplied from the colorimetry element 17, converts them to digital signals and outputs the digital signals to the CPU 39.

The timer 45 has an internal clock circuit and outputs the data corresponding to the current time to the CPU 39.

The diaphragm drive circuit 53 sets the diameter of the aperture stop 54 to a predetermined value. The aperture stop 54 is arranged between the shooting lens 3 and the CCD 20 and changes the aperture for the light entering from the shooting lens 3 to the CCD 20.

The CPU 39 prevents the operation of the photometry circuit 51 and the colorimetry circuit 52 when the LCD cover 14 is open and operates the photometry circuit 51 and the colorimetry circuit 52 when the LCD cover 14 is closed. The CPU 39 also stops the operation of the CCD 20 (electronic shutter operation, for example) until the release switch 10 is in the half-depressed position.

The CPU 39 receives the light measurement results of the photometry element 16 and the color measurement results of the colorimetry element 17 by controlling the photometry circuit 51 and the colorimetry circuit 52 when the operation of the CCD 20 is stopped. Moreover, the CPU 39 computes a white balance adjustment value corresponding to the color temperature supplied from the colorimetry circuit 52 using a predetermined table, and supplies the white balance value to the image processing unit 31. In other words, when the LCD cover 14 is closed, the LCD 6 is not used as an electronic viewfinder, hence the operation of the CCD 20 stops. Since the CCD 20 consumes a large amount of electric power, by stopping the operation of the CCD 20 as described above, the power of the batteries 21 may be conserved.

Moreover, when the LCD cover 14 is closed, the image processing unit 31 does not execute various processes until the release switch 10 is operated (until the release switch 10 is in the half-depressed position). Also, when the LCD cover 14 is closed, the diaphragm drive circuit 53 does not execute operations such as changing of the diameter of the aperture stop 54 until the release switch 10 is operated (until the release switch 10 is in the half-depressed position).

Moreover, the CPU 39 causes the light emitting unit 4 to emit light, at the user's discretion, by controlling the strobe drive circuit 37, and causes the red eye reduction LED 15 to emit light, at the user's discretion, prior to causing the light emitting unit 4 to emit light by controlling the red eye reduction LED drive circuit 38. Here, the CPU 39 causes the light emitting unit 4 not to emit light when the LCD cover 14 is open (in other words, when the electronic viewfinder is used). By doing this, the object may be shot as an image being displayed in the electronic viewfinder.

The CPU 39 records in the shooting image recording area of the memory card 24 information concerning the date of shooting supplied from the timer 45 as header information of the image data.

Moreover, after compressing the digitized sound information, the CPU 39 temporarily records the digitized and compressed sound data to the buffer memory 36 and then records it in the predetermined area (sound recording area) of the memory card 24. As header information of the sound data, the data concerning the recording date is recorded simultaneously in the sound recording area of the memory card 24.

The CPU 39 executes the auto focus operation by moving the shooting lens 3 by controlling the lens drive circuit 30 and changes the diameter of the aperture stop 54 by controlling the diaphragm drive circuit 53.

Also, the CPU 39 displays settings and the like for the various operations on the display device 26 inside the viewfinder by controlling the display circuit 40.

The CPU 39 exchanges data with an external apparatus (not shown) through the interface (I/F) 48. The CPU 39 receive signals from the operation key area 7 and processes them appropriately.

When a certain position on the touch tablet 6A is pressed by the pen 41 (pen type pointing member), the CPU 39 reads the X-Y coordinates of the position being pressed and accumulates the coordinate data (memo information to be explained later) in the buffer memory 36. The CPU 39 records the memo information which is accumulated in the buffer memory 36 in the memo information recording area of the memory card 24 together with header information consisting of the memo information input date.

Next, various operations of the electronic camera 1 of the present embodiment are explained. First, the operation of the electronic viewfinder in the LCD 6 of the present apparatus will be described.

When the user half-depresses the release switch 10, the DSP 33 determines, in conjunction with the value of the signal indicating the status of the LCD switch 25 supplied from the CPU 39, whether or not the LCD cover 14 is open. If it is determined that the LCD cover 14 is closed, the operation of the electronic viewfinder is not executed and the DSP 33 stops the process until the release switch 10 is operated. Moreover, if the LCD cover 14 is closed, the CPU 39 stops the operation of the CCD 20, the image processing unit 31 and the diaphragm drive circuit 53. The CPU 39 operates the photometry circuit 51 and the colorimetry circuit 52 instead of the CCD 20 and supplies the measurement results to the image processing unit 31. The image processing unit 31 uses the measurement results to control the white balance and the brightness value.

If the release switch 10 is operated, the CPU 39 operates the CCD 20 and the diaphragm drive circuit 53.

On the other hand, if the LCD cover 14 is open, the CCD 20 executes the electronic shutter operation with a predetermined exposure time for each predetermined time interval, executes the photoelectrical conversion of the photo image of the object which is gathered by the shooting lens 3 and outputs the resulting image signals to the image processing unit 31.

The image processing unit 31 controls the white balance and brightness value, executes the predetermined process on the image signals and then outputs the image signals to the A/D conversion circuit 32. In this instance, if the CCD 20 is operating, the image processing unit 31 uses an adjusted value which is computed by the CPU 39 based on the output from the CCD 20 and which is used for controlling the white balance and brightness value.

The A/D conversion circuit 32 converts the image signal (analog signal) into the image data (digital signal), and outputs the image data to the DSP 33. The DSP 33 outputs the image data to the frame memory 35 and causes the LCD 6 to display the image corresponding to the image data.

In this manner, the CCD 20 operates the electronic shutter at a predetermined time interval when the LCD cover 14 is open. The CCD 20 also operates the electronic viewfinder by converting the signal output from the CCD 20 into image data, outputting the image data to the frame memory 35 and continuously displaying the image of the object on the LCD 6.

On the other hand, if the LCD cover 14 is closed, the electronic viewfinder is not operated and operation of the CCD 20, the image processing unit 31 and the diaphragm drive circuit 53 are halted to conserve energy.

Next, shooting of the object using the present apparatus will be described.

First, the case in which the continuous shooting mode switch 13 is switched to the S-mode (the mode in which only one frame is shot) will be explained. Power is introduced to the electronic camera 1 by switching the power switch 11 shown in FIG. 2 to the “ON” position.

The shooting process of the object begins when the release switch 10 is pressed after verifying the object through the viewfinder 2. If the LCD cover 14 is closed, the CPU 39 begins operation of the CCD 20, the image processing unit 31 and the diaphragm drive circuit 53 when the release switch 10 is in the half-depressed position, and begins the shooting process of the object when the release switch 10 reaches the fully-depressed position.

The photo image of the object being observed through the viewfinder 2 is gathered by the shooting lens 3 and forms an image on the CCD 20, which has a plurality of pixels. The photo image which is imaged on the CCD 20 is photoelectrically converted into an image signal pixel by pixel and is sampled by the image processing unit 31. The image signal which is sampled by the image processing unit 31 is supplied to the A/D conversion circuit 32, where it is digitized, and is output to the DSP 33.

The DSP 33, after outputting the image temporarily to the buffer memory 36, reads the image data from the buffer memory 36, compresses the image data using JPEG (Joint Photographic Experts Group) standards which is a combination of a discrete cosine transformation, quantization, and Huffman encoding, and records the image data in the shooting image recording area of the memory card 24. At this time, the shooting date data is recorded as header information of the shooting image data in the shooting image recording area of the memory card 24.

In this instance, if the continuous shooting mode switch 13 is switched to the S-mode, only one frame is shot and further shooting does not take place even if the release switch 10 is held in the fully-depressed position. Moreover, while the release switch 10 is held in the fully-depressed position, the image which has been shot is displayed on the LCD 6 when the LCD cover 14 is open.

Next, the case in which the continuous shooting mode switch 13 is switched to the L-mode (a mode in which 8 frames per second are shot continuously) will be explained. Power is introduced to the electronic camera 1 by switching the power switch 11 to the “ON” position.

The shooting process of the object begins when the release switch 10 is pressed. If the LCD cover 14 is closed, the CPU 39 begins operation of the CCD 20, the image processing unit 31 and the diaphragm drive circuit 53 when the release switch 10 is in the half-depressed position, and begins the shooting process of the object when the release switch 10 reaches the fully-depressed position.

The photo image of the object being observed through the viewfinder 2 is gathered by the shooting lens 3 and forms an image on the CCD 20. The photo image which is imaged on the CCD 20 is photoelectrically converted into an image signal pixel by pixel and is sampled by the image processing unit 31 at a rate of 8 times per second. Moreover, the image processing unit 31 thins out three-fourths of the pixels of the image signal.

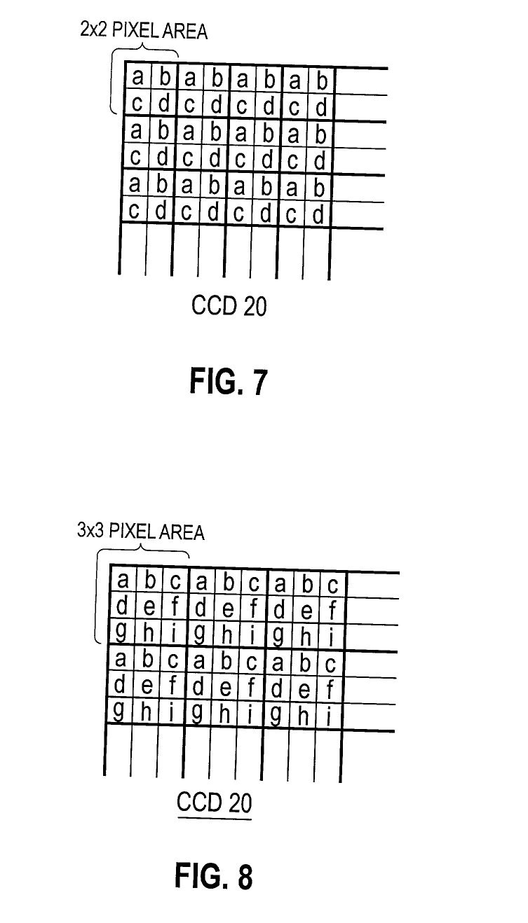

In other words, the image processing unit 31 divides the pixels in the CCD 20 into areas composed of four pixels in a 2×2 pattern as shown in FIG. 7 and samples the image signal of one pixel which is in a predetermined location from each area, thinning out the remaining 3 pixels.

For example, during the first sampling (first frame), the pixel a which is located on the left upper corner is sampled and other pixels b, c and d are thinned out. During the second sampling (second frame), the pixel b which is located on the right upper corner is sampled and other pixels a, c and d are thinned out. Likewise, during the third and the fourth sampling, the pixels c and d which are respectively located at the left lower corner and the right lower corner are sampled and the rest are thinned out. In short, each pixel is sampled once during four samplings.

The image signals (image signals of one-fourth of all the pixels in the CCD 20) that are sampled by the image processing unit 31 are supplied to the AID conversion circuit 32 where they are digitized and output to the DSP 33.

The DSP 33, after outputting the image temporarily to the buffer memory 36, reads the image data from the buffer memory 36, compresses the image data using the JPEG method and records the digitized and compressed shooting image data in the shooting image recording area of the memory card 24. At this time, the shooting date data is recorded as header information of the shooting image data in the shooting image recording area of the memory card 24.

Thirdly, the case in which the continuous shooting mode switch 13 is switched to the H-mode (a mode in which 30 frames are shot per second) is described. Power is introduced to the electronic camera 1 by switching the power switch 11 to the “ON” position.

The shooting process of the object begins when the release switch 10 is pressed. If the LCD cover 14 is closed, the CPU 39 begins operation of the CCD 20, the image processing unit 31 and the diaphragm drive circuit 53 when the release switch 10 is in the half-depressed position, and begins the shooting process of the object when the release switch 10 reaches the fully-depressed position.

The photo image of the object being observed through the viewfinder 2 is gathered by the shooting lens 3 and forms an image on the CCD 20. The optical image which is imaged on the CCD 20 is photoelectrically converted into an image signal pixel by pixel and is sampled 30 times per second by the image processing unit 31. Moreover, the image processing unit 31 thins out eight-ninths of the pixels of the image signal.

In other words, the image processing unit 31 divides the pixels in the CCD 20 into areas composed of nine pixels in a 3×3 pattern as shown in FIG. 8 and samples the image signal of one pixel which is in a predetermined location from each area. The remaining 8 pixels are thinned out.

For example, during the first sampling (first frame), the pixel a which is located on the left upper corner of each area is sampled and the other pixels (b through i) are thinned out. During the second sampling (second frame), the pixel b which is located on the right of a is sampled and the other pixels (a and c through i) are thinned out. Likewise, during subsequent samplings, the pixels c, d, etc., are sampled respectively and the rest are thinned out. In short, each pixel is sampled once during nine samplings.

The image signals (image signals of one-ninth of all the pixels in the CCD 20) that are sampled by the image processing unit 31 are supplied to the A/D conversion circuit 32 where they are digitized and output to the DSP 33.

The DSP 33, after outputting the image temporarily to the buffer memory 36, reads the image data from the buffer memory 36, compresses the image data using the JPEG method and records the digitized and compressed shooting image data in the shooting image recording area of the memory card 24.

Light may be shined on the object, if necessary, by operating the light emitting unit 4. However, when the LCD cover 14 is open, or when the LCD 6 executes the electronic viewfinder operation, the CPU 39 prevents the light emitting unit 4 from emitting light.

Next, the operation in which two dimensional information (pen input information) is input from the touch tablet 6A will be described.

When the touch tablet 6A is pressed by the tip of the pen 41, the X-Y coordinates of the contact point are supplied to the CPU 39 and are stored in the buffer memory 36. Moreover, the CPU 39 writes data to the address in the frame memory 35 which corresponds to the X-Y coordinates, and a memo corresponding to the contact point of the pen 41 may be displayed at the X-Y coordinates on the LCD 6.

Since the touch tablet 6A is made of transparent material, the user is able to view the point being displayed on the LCD 6. This gives an impression that the input is made by the pen directly onto the LCD 6. Moreover, when the pen 41 is moved on the touch tablet 6A, a line tracing the motion of the pen 41 is displayed on the LCD 6. If the pen 41 is moved intermittently on the touch tablet 6A, a dotted line tracing the motion of the pen 41 is displayed on the LCD 6. In this manner, the user is able to input memo information of desired letters, drawings and the like to the touch tablet 6A (LCD 6).

Moreover, if the memo information is input by the pen 41 when the shooting image is already displayed on the LCD 6, the memo information is synthesized (combined) with the shooting image information by the frame memory 35 and both are displayed together on the LCD 6. By operating a predetermined pallet, the user is able to choose the color of the memo to be displayed on the LCD 6.

If the execution key 7B of the control key area 7 is pressed after memo information is input to the touch tablet 6A by the pen 41, the memo information which is accumulated in the buffer memory 36 is supplied, along with header information of the input date, to the memory card 24 and is recorded in the memo information recording area of the memory card 24.

In this instance, the memo information which is recorded on the memory card 24 is compressed information. The memo information which is input in the touch tablet 6A contains information having a high spatial frequency. Hence, if the aforementioned JPEG method is used for the compression of the memo information, the compression efficiency becomes poor and the information amount is not reduced, resulting in a longer time for compression and decompression. Moreover, compression by the JPEG method is lossey compression, hence it is not suitable for the compression of memo information with a small information amount. (This is because gather and smearing due to missing information become noticeable when information is decompressed and displayed on the LCD 6.)

Hence, in the configuration of the present embodiment, memo information is compressed using the run length method which is used in facsimile machines and the like. The run length method is a method in which a memo screen is scanned in the horizontal direction and memo information is compressed by encoding each continuous length of information of each color such as black, white, red and blue as well as each continuous length of non-information (where there is no pen input).

Using the run length method, memo information is compressed to have a minimum amount and the loss of information is minimized even when the compressed memo information is decompressed. Moreover, it is feasible to not compress memo information if the information amount is relatively small.

Moreover, as mentioned above, if the memo information is input by the pen 41 when the shooting image is already displayed on the LCD 6, the pen input is synthesized with the shooting image information by the frame memory 35 and the synthesized image of the shooting image and the memo is displayed on the LCD 6. The shooting image data is recorded in the shooting image recording area and the memo information is recorded in the memo information recording area of the memory card 24. Because the two pieces of information are recorded separately, the user is able to delete one of the two images (memo, for example) from the combined synthesized image, enabling further compression of each type of information by means of a separate compression method.

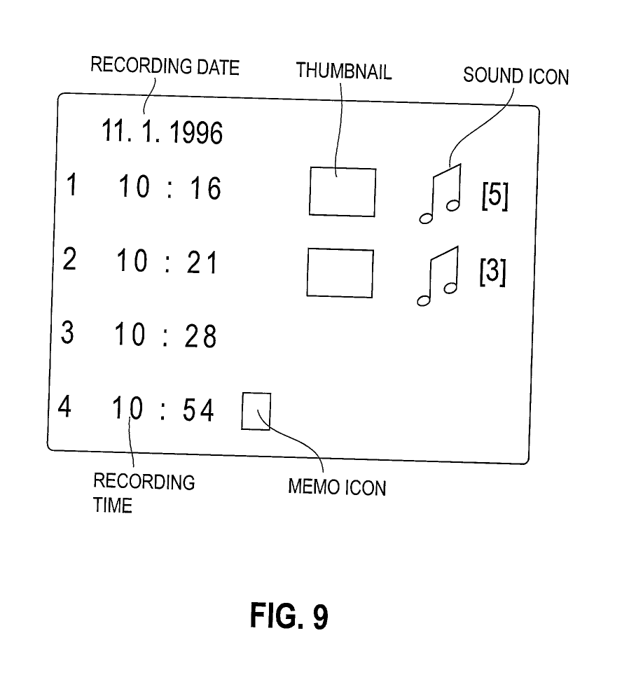

When data are recorded in the sound recording area, the shooting image recording area and/or the memo information recording area of the memory card 24, a table may be displayed in the LCD 6 as shown in FIG. 9.

In the display screen of the LCD 6 which is shown in FIG. 9, the date of recording information (recording date) (Nov. 1, 1996 in this case) is displayed on the top section of the screen. The number and the recording time of the information recorded on the recording date are displayed on the left-most side of the screen.

To the right of the recording time, a thumbnail image is displayed when a shooting image is present. The thumbnail image is formed by thinning out (reducing) the bit map data of each image data of the shooting image data which is recorded in the memory card 24. Information with this display is information containing shooting image information. In other words, information which is recorded (input) at “10:16”, and “10:21” contain shooting image information, but information which is recorded at other times does not contain shooting image information.

The memo icon indicates that a predetermined memo is recorded as line drawing information.

Sound icons (musical notes) are displayed to the right of the thumbnail image display area. To the right of the sound icons, sound recording times (in seconds) are displayed (these will not be displayed if sound information is not input).

The user selects and designates the information to be reproduced by pressing, with the tip of the pen 41, a desired icon, and the selected information is reproduced by pressing, with the tip of the pen 41, the execution key 7B as described in FIG. 2.

For example, if the sound icon aligned with “10:16” in FIG. 9 is pressed by the pen 41, the CPU 39 reads the sound data corresponding to the selected recording date (10:16) from the memory card 24, decompresses the sound data and then supplies the sound data to the A/D and D/A conversion circuit 42. The A/D and D/A conversion circuit 42 converts the data to analog signals and then reproduces the sound through the speaker 5.

In reproducing the shooting image data which is recorded in the memory card 24, the user selects the information by pressing the desired thumbnail image with the tip of the pen 41 and then reproduces the selected information by pressing the execution key 7B. In other words, the CPU 39 instructs the DSP 33 to read the shooting image data corresponding to the selected recording date from the memory card 24. The DSP 33 decompresses the shooting image data (compressed shooting data) which is read from the memory card 24 and displays on the LCD 6 the shooting image data accumulated as bit map data in the frame memory 35.

The image which is shot in the S-mode is displayed as a still image on the LCD 6. This still image is obviously the image reproduced from the image signals of all the pixels in the CCD 20.

The image which is shot in the L-mode is displayed continuously (as a moving picture) at 8 frames per second on the LCD 6. In this case, the number of pixels being displayed in each frame is one-fourth of all the pixels in the CCD 20. Human vision is sensitive to the deterioration of resolution of a still image. Hence, the user may easily detect the thinning out of the pixels in the still image. However, in the L-mode where images of 8 frames are reproduced per second, the number of pixels in each frame is one-fourth of the number of pixels of the CCD 20, but the information amount per unit of time doubles compared to the still image because the human eyes observe images of 8 frames per second.

In other words, assuming the number of pixels of one frame of the image which is shot in the S-mode to be one, the number of pixels in one frame of the image which is shot in the L-mode becomes one-fourth. When the image (still image) which is shot in the S-mode is displayed on the LCD 6, the amount of information viewed by the human eye per second is 1 ((number of pixels (1))×(number of frames (1))). On the other hand, when the image which is shot in the L-mode is displayed on the LCD 6, the amount of information viewed by human eye per second is 2 ((number of pixels (¼))×(number of frames (8))). Therefore, in the L-mode, twice as much information is viewed by the human eye per unit of time as is viewed in the S-mode. As a result, even when the number of pixels in one frame is reduced to one-fourth, the deterioration of the image quality during reproduction is not of concern to the user.

Moreover, in the configuration of the present embodiment, different sampling is executed for each frame and the sampled pixels are made to be displayed on the LCD 6. As a result, due to the after image effect which occurs to the human eye, the user can view the image which is shot in the L-mode and which is displayed on the LCD 6 without being concerned about the deterioration of the image, even when three-fourths of the pixels are thinned out.

Moreover, the image which is shot in the H-mode is displayed on the LCD 6 at the rate of 30 frames per second. The number of pixels displayed in each frame is one-ninth of the total number of the pixels of the CCD 20, but the user can view the image without being concerned about the deterioration of image quality for the same reason as in the case of the L-mode.

In the present embodiment, because the image processing unit 31 thins out the pixels in the CCD 20 when the object is shot in the L-mode or H-mode, the load on the DSP 33 and the CCD driving circuit 34 is reduced. This enables the low speed and low power operation of these units, resulting in low cost and low energy consumption operation.

However, in the present embodiment, it is also possible to not only photograph optical images of an object but also to record memo (line drawing) information. A photography mode and a memo input mode are prepared for inputting this information and these modes are appropriately selected in accordance with the operation by the user so that the input of information is smoothly executed.

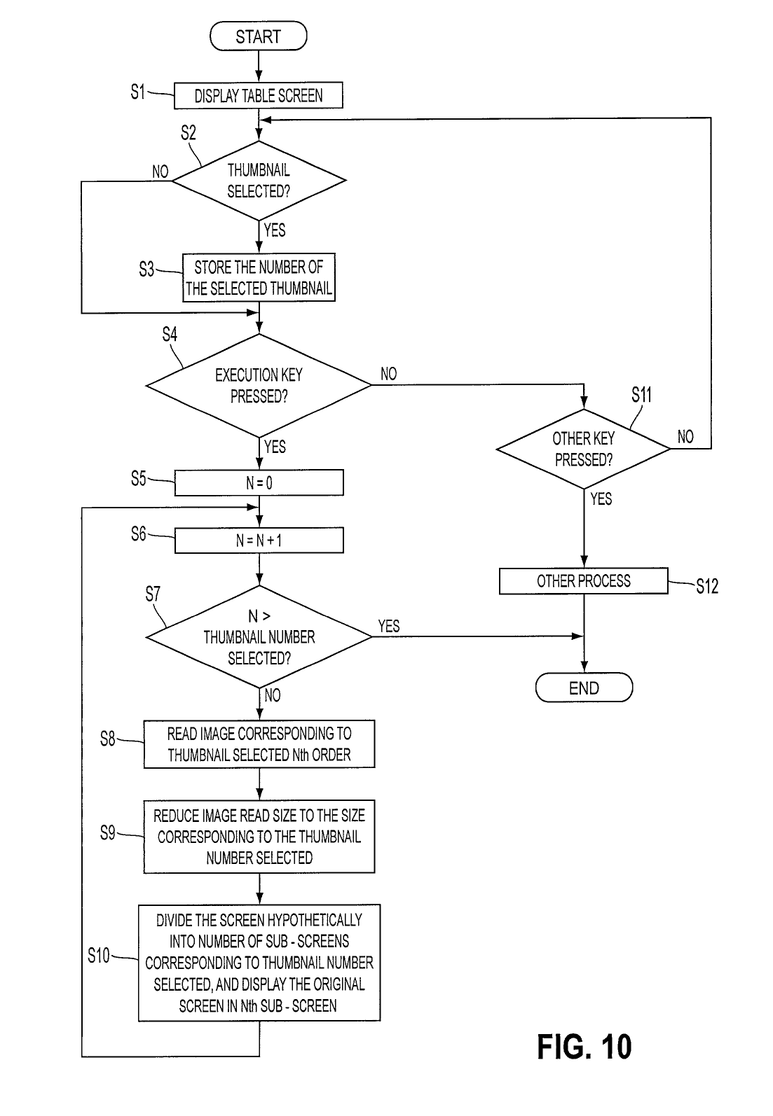

Referring to FIG. 10, the sequence will be described in which a plurality of thumbnail images are selected and the images corresponding to the selected thumbnail images are displayed so as to be lined up on the screen in the order of selection.

In step S1, a screen showing a table is displayed on the LCD 6. Hereafter, for purposes of demonstration, five information files are displayed in the table on the screen. In step S2 a determination is made as to whether a thumbnail image displayed on the screen has been selected.

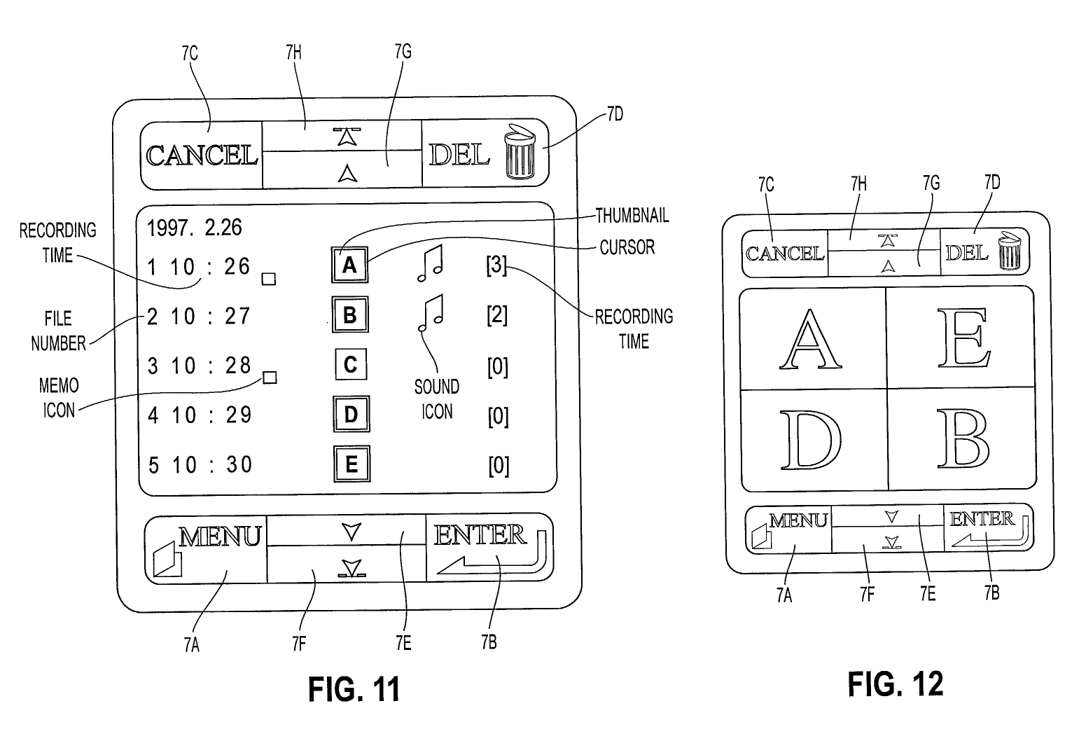

When it is determined in step S2 that a thumbnail image has been selected, the program moves to step S3 and the file number of the selected thumbnail image is recorded. Furthermore, a rectangular cursor is displayed, as shown in FIG. 11, around the selected thumbnail image to indicate that it has been selected. Following this, the program moves to step S4. Alternatively, when it is determined that a thumbnail image has not been selected, no process is executed and the program moves to step S4.

In step S4, a determination is made as to whether the execution key 7B has been pressed. When it is determined that the execution key 7B has not been pressed, the program moves to step S11 where a determination is made as to whether another key has been pressed. When it is determined that no other key has been pressed, the program returns to step S2 and repeatedly executes step S2 and the steps following step S2. Accordingly, in step S2 it is possible to select a plurality of thumbnail images. In the case of the present example, it will be assumed that thumbnail images corresponding to images A, E, D and B have been selected in that order. In addition, when it is determined in step S11 that another key has been pressed, another process is accomplished in step S12 and then the processes are concluded.

When it is determined in step S4 that the execution key 7B has been pressed, the selection of thumbnail images is deemed to have been completed, so the program moves to step S5 where a designated variable N is set to an initial value of 0.

In step S6, the value of the variable N is incremented by 1. In step S7, a determination is made as to whether the value of the variable N is larger than a value corresponding to the number of selected thumbnail images (the thumbnail number). When it is determined that the value of the variable N is not larger than a value corresponding to the number of thumbnail images, the program moves to step S8.

In step S8, the original image corresponding to the Nth thumbnail image selected is read from the memory card 24 under the control of the CPU 39. Furthermore, in step S9, the image that has been read is reduced to a size in accordance with the number of selected thumbnail images. For example, if the number of selected thumbnail images is 2 to 4, the screen of the LCD 6 is hypothetically partitioned into four small screens, as is described below. When the number of selected thumbnail images is 5 to 9, the screen of the LCD 6 is hypothetically partitioned into nine small screens. Furthermore, the original images corresponding to the selected thumbnail images are reduced to the size of each partitioned small screen.

In step S10, the screen of the LCD 6 is hypothetically partitioned into small screens, the number of which is in accordance with the number of selected thumbnail images, as shown in FIG. 12, under the control of the CPU 39. The reduced image reduced in step S9 is displayed in the Nth small screen. Following this, the program returns to step S6 and repeatedly executes step S6 and the steps following step S6 until the value of the variable N is greater than the number of selected thumbnail images (in the case of this example, 4).

Furthermore, in the case of this example, the reduced image of image A is displayed in the upper left of the screen, the reduced image of image E is displayed in the upper right of the screen, the reduced image of image D is displayed in the lower left of the screen and the reduced image of image B is displayed in the lower right of the screen. In this way, the selected images are displayed in the small screens so as to be lined up on the screen in the order of selection.

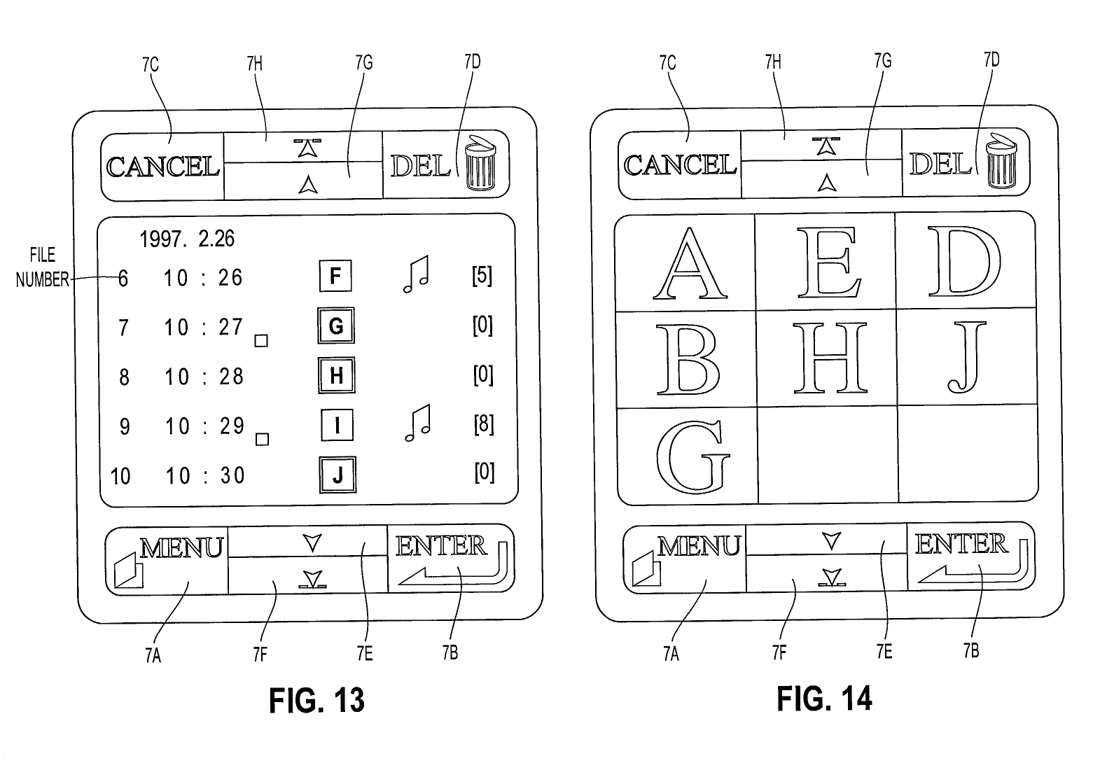

In addition, by repeating the processes in steps S2 through S4 and S11 in FIG. 10, when the images A, E, D and B, and the images H, J and G are selected in that order, as shown in FIG. 13, the screen of the LCD 6 is hypothetically partitioned into nine small screens, as shown in FIG. 14. This partitioning of the screen is performed by the above-described processes in steps S5 through S10 and results in the following: the reduced image of the image A is displayed in the small screen on the left side of the top row, the reduced image of the image E is displayed in the small screen in the center of the top row, the reduced image of the image D is displayed in the small screen on the right side of the top row, the reduced image of the image B is displayed on the left side of the middle row, the reduced image of the image H is displayed in the center of the middle row, the reduced image of the image J is displayed on the right side of the middle row and the reduced image of the image G is displayed on the left side of the bottom row.

Furthermore, when the determination in step S7 is that the value of the variable N is larger than the number of selected thumbnail images, that is to say when the reduced images corresponding to all of the selected thumbnail images have been displayed on small screens, the process is concluded.

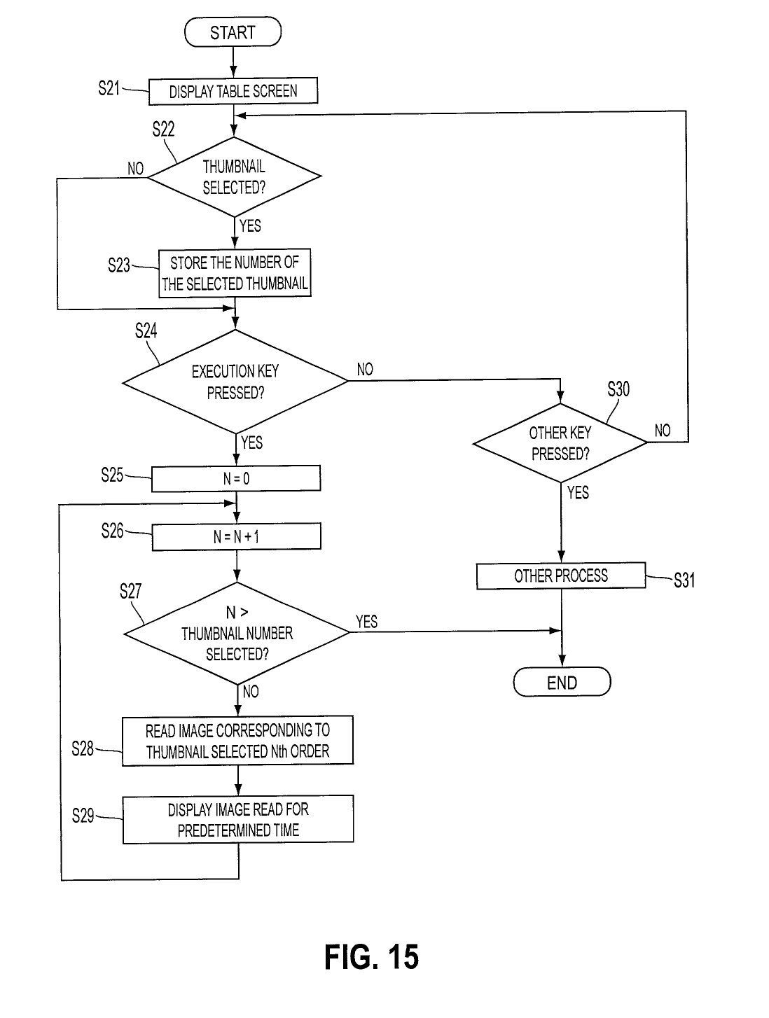

Next, the sequence will be described for another process wherein a plurality of images selected on a screen showing a table are displayed on the screen of the LCD 6 in the order of selection, with reference to FIG. 15.

First, in step S21 a screen showing a table is displayed on the LCD 6. In step S22 a determination is made as to whether a thumbnail image on the screen has been selected. When it is determined that a thumbnail image has been selected, the program moves to step S23 where the file number of the selected thumbnail image is recorded. In step S24 a determination is made as to whether the execution key 7B has been selected.

When it is determined in step S24 that the execution key 7B has not been selected, the program moves to step S30 where a determination is made as to whether another key has been pressed. When it is determined that no other key has been pressed, the program returns to step S22 and repeatedly executes step S22 and the processes following step S22. Accordingly, it is possible to select a plurality of thumbnail images in step S22 by repeatedly executing the loop comprising steps S22, S23, S24 and S30.

In addition, when it is determined in step S22 that the selection of a thumbnail image has not been accomplished, the program moves to step S24. When it is determined in step S24 that the execution key 7B has been pressed, the program moves to step S25 where the variable N is set to an initial value of 0. In step S26 the value of the variable N is incremented by one. In step S27, a determination is made as to whether the value of the variable N is larger than a value corresponding to the number of thumbnail images selected in step S22.

When it is determined that the value of the variable N is less than or equal to the number of thumbnail images selected in step S22, the program moves to step S28 where the image corresponding to the Nth selected thumbnail image is read from the memory card 24. In step S29 the image read in step S28 is displayed for a designated time (e.g., 3 seconds) on the LCD 6. When the designated time has elapsed, the program returns to step S26 and the processes in steps S26 through S29 are repeatedly executed for a number of times corresponding to the number of selected thumbnail images. Furthermore, when the above-described processes have been repeated for the number of times corresponding to the number of selected thumbnail images, it is determined in step S27 that the value of the variable N is larger than the value corresponding to the number of thumbnail images selected in step S22, so the processes are concluded.

In addition, when it is determined in step S30 that another key has been pressed, the program moves to step S31 and another process is executed, following which the processes are concluded.

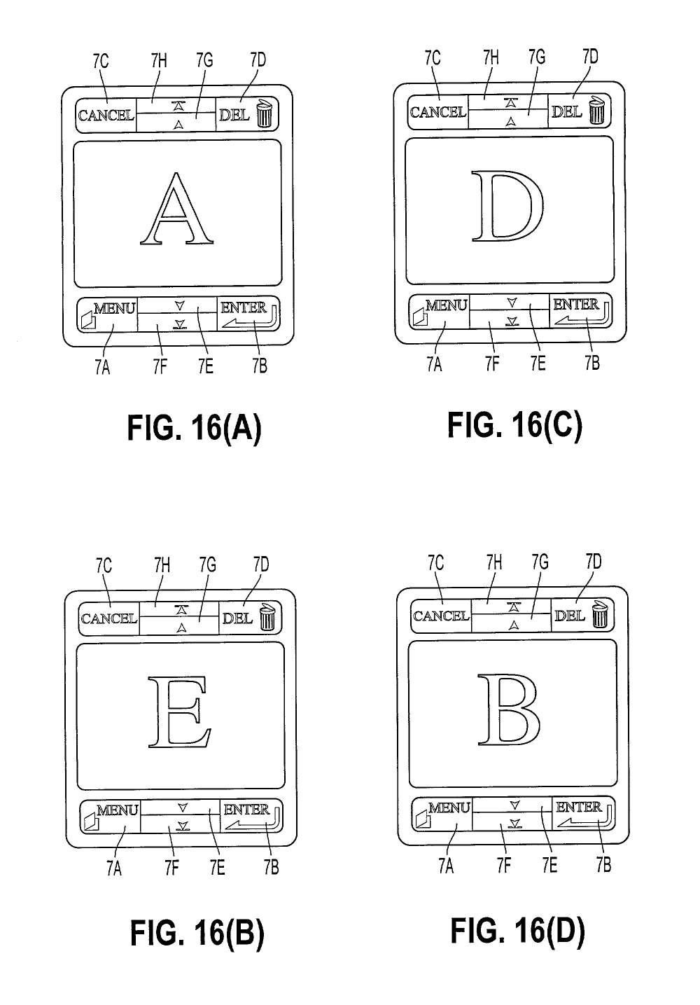

In the case of this example, the number of selected thumbnail images is 4, and hence the processes in steps S26 through S29 are executed four times. As shown in FIG. 16A, after the image A has been displayed for a designated time, e.g. 3 seconds, the image E is displayed on the LCD 6, as shown in FIG. 16B. Following this, after 3 seconds have elapsed, the image D is displayed on the LCD 6, as shown in FIG. 16C, and then after 3 seconds have elapsed, the image B is displayed on the LCD 6, as shown in FIG. 16D.

In this way, it is possible to select a plurality of thumbnail images and to display on the entire screen of the LCD 6 the original images corresponding to the selected thumbnail image for a designated time interval and in the order of selection.

The program that causes the CPU 39 to execute the processes shown in the flowcharts in FIG. 10 and FIG. 15 can be stored in the memory card 24 or the ROM 43 of the electronic camera 1, or the like. In addition, this program may be supplied to the user stored in the ROM 43 or the memory card 24 beforehand, or may be supplied to the user stored on CD-ROM (compact disk-read only memory) or the like so as to be copyable to the ROM 43 or the memory card 24. If the program is to be copyable to the ROM 43, the ROM 43 is comprised for example of an EEPROM (electrically erasable and programmable read only memory) that can be electrically overwritten. The program also could be provided to the user over a communications network such as the Internet (world wide web).

In the above-described embodiment, examples were described wherein four or nine thumbnail images were selected, but it is possible to select an arbitrary number of thumbnail images within the scope of the number of images stored in the memory card 24. In addition, it is possible to select a thumbnail image a multiple number of times, and in this case, it is possible to select an arbitrary number of thumbnail images. In addition, the screen layout in the configuration of the above-described embodiment is one example, and is not intended to be limiting. Furthermore, the numbers in the configuration of the above-described embodiment are examples, and are not intended to be limiting.

The reduced images that are to be displayed can be created any number of ways. For example, the reduced images can be formed by thinning out the original shooting image information. The amount of thinning would depend on the size of the screen, and thus would depend on the number of selected images to be displayed. The thinned images could be displayed as is or could undergo further image processing (e.g., interpolation) to improve the image quality. When the selected image was recorded in the L-mode or H-mode, it may not be necessary to further thin the image of a frame. The reduced image data also could be displayed as the thinned image, although this may have a poor image quality. The reducing is performed by the DSP 33 alone or combined with the CPU 39.

Although the described example is displayed reduced shooting images, the invention also is applicable to the line drawings (memo information). Thus, reduced line drawings can be displayed alone or synthesized with a corresponding shooting image. The plurality of reduced images displayed on the screen can include a combination of reduced shooting images and line drawings, for example.

Although the JPEG and run length encoding compression techniques were described, other compression techniques (or no compression at all) can be used with the invention.

Although a touch tablet with input pen were described as structures through which selections and commands can be input, the invention is not limited to such structure. For example, the touch tablet can be actuable by the user's finger. Additionally, selections and commands can be input without using a touch tablet. For example, a cursor can be moved (e.g., via a mouse) and selections or commands can be made by clicking.

The invention is not limited to the implementation by a programmed general purpose computer as shown in the preferred embodiment. For example, the invention can be implemented using one or more special purpose integrated circuit(s) (e.g., ASIC). It will be appreciated by those skilled in the art that the invention can also be implemented using one or more dedicated or programmable integrated or other electronic circuits or devices (e.g., hardwired electronic or logic circuits such as discrete element circuits, or programmable logic devices such as PLDs, PLAs, PALs or the like). In general, any device or assembly of devices on which a finite state machine capable of implementing the flowcharts shown in FIGS. 10 and 15 can be used.

While this invention has been described in conjunction with specific embodiments thereof, it is evident that many alternatives, modifications and variations will be apparent to those skilled in the art. Accordingly, the preferred embodiments of the invention set forth herein are intended to be illustrative, not limiting. Various changes may be made without departing from the spirit and scope of the invention as defined in the following claims.

What is claimed is:

1. An information processing apparatus, comprising:
imaging means for producing image information representative of images;
memory means for storing the image information produced by said imaging means;
selection means for selecting images corresponding to the image information from among the image information stored in said memory means;
reduction means for reducing the image selected by said selection means; and
display control means for displaying on a screen the reduced images reduced by said reduction means, wherein when a plurality of the images are selected by said selection means, said display control means displays the reduced images so that the reduced images are arranged in a designated order on said screen in correspondence with the order in which the images were selected by said selection means.

2. The information processing apparatus as defined in claim 1, further comprising:
partition means for partitioning the screen into a plurality of smaller screens in accordance with the number of the images selected by said selection means, wherein said display control means displays each of the reduced images on a corresponding area of said smaller screens.

3. The information processing apparatus as defined in claim 1, further comprising:
reduced image selection means for selecting images from among the reduced images,
wherein when the images selected from among the reduced images are selected by said reduced image selection means, said display control means displays on said screen the images corresponding to the reduced images prior to reduction thereof.

4. The information processing apparatus as defined in claim 1, further comprising:
line drawing input means for inputting line drawings,
wherein said memory means stores the line drawings that have been input by said line drawing input means, and
when the line drawings input by said line drawing input means are made to correspond to the images selected by said selection means, said reduction means reduces the line drawings stored in said memory means and said display control means displays the line drawings reduced by said reduction means along with the reduced images.

5. The information processing apparatus as defined in claim 4, wherein when the line drawings stored in said memory means have been selected by said selection means, said reduction means reduces the line drawings and said display control means displays reduced line drawings that comprise the line drawings reduced by said reduction means.

6. The information processing apparatus as defined in claim 1, further comprising:
display means for displaying the images and the reduced images.

7. The information processing apparatus as defined in claim 6, wherein said display means displays line drawings and reduced line drawings.

8. A recording medium, on which is recorded a computer-readable control program for use by an information processing apparatus, said control program including instructions causing the information processing apparatus to:
enable selection of a plurality of the images stored in a memory of said information processing apparatus;
reduce the selected images; and
display the plurality of reduced images on a display screen in a designated order in correspondence with the order in which the images were selected.

9. The recording medium of claim 8, wherein said control program further includes instructions to:
partition the display screen into a plurality of smaller screens in accordance with the number of selected images, and wherein:
each reduced image is displayed in a corresponding one of the smaller screens.

10. The recording medium of claim 8, wherein the plurality of images include photographed images.

11. The recording medium of claim 10, wherein the plurality of images include line drawings.

12. The recording medium of claim 8, wherein the plurality of images include line drawings.

13. An information processing apparatus, comprising:
an image input device;
a memory which stores the images that have been input by said image input device;
a selector which selects images from among the images stored in said memory; and
a controller which reduces the images selected by said selector and displays on a screen the reduced images, wherein when a plurality of the images are selected, said controller displays the reduced images arranged in a designated order on said screen in correspondence with the order in which the images were selected.

14. The information processing apparatus as defined in claim 13, wherein said controller partitions the screen into a plurality of smaller screens in accordance with the number of the images selected and displays each of the reduced images on at least one of said smaller screens.

15. The information processing apparatus as defined in claim 13, further comprising:
a reduced image selector which selects images from among the reduced images,
wherein when the images selected from among the reduced images are selected by said reduced image selector, said controller displays on said screen the images corresponding to the reduced images prior to reduction thereof.

16. The information processing apparatus as defined in claim 13, further comprising:
a line drawing input device which inputs line drawings,
wherein said memory stores the line drawings that have been input by said line drawing input device, and
when the line drawings input by said line drawing input device are made to correspond to the images selected by said selector, said controller reduces the line drawings stored in said memory and displays the reduced line drawings along with the reduced images.

17. The information processing apparatus as defined in claim 16, wherein when the line drawings stored in said memory have been selected by said selector, said controller reduces the line drawings and displays the reduced line drawings.

18. The information processing apparatus as defined in claim 13, further comprising:
a display which displays the images and the reduced images.

19. The information processing apparatus as defined in claim 18, wherein said display displays line drawings and reduced line drawings.

20. A method for processing and displaying images, comprising the steps of:
selecting images from among a plurality of stored images;
reducing the selected images; and
displaying the reduced images in a designated order in correspondence with the order in which the images were selected.

21. The method of claim 20, further comprising the steps of:
partitioning a screen on which the reduced images are displayed into a plurality of smaller screens in accordance with the number of the images selected; and
displaying each of the reduced images on at least one of said smaller screens.

22. The method of claim 20, further comprising the steps of:
selecting images from among the reduced images; and
displaying on said screen the images corresponding to the reduced images prior to reduction thereof.

23. The method of claim 20, further comprising the steps of:
inputting line drawings;
storing the line drawings that haste been input;
corresponding the line drawings to the images selected;
reducing the line drawings; and
displaying the reduced line drawings.

24. The method of claim 23, further comprising the step of:
displaying the reduced line drawings along with the reduced images.

25. The method of claim 24, further comprising the step of:
displaying the line drawings.

26. The method of claim 20, further comprising, prior to said selecting step, imaging an object to create said images, and storing said images in a memory from which the images are selected.

27. An information processing apparatus comprising:
a selector that selects images from among a plurality of images stored in a memory; and
a controller that reduces the selected images and displays on a screen the reduced images, wherein when a plurality of the images are selected, said controller displays the reduced images arranged in a designated order on said screen in correspondence with the order in which the images were selected.

28. The information processing apparatus as defined in claim 27, wherein said controller partitions the screen into a plurality of smaller screens in accordance with the number of the images selected and displays each of the reduced images on at least one of said smaller screens.

29. The apparatus of claim 27, wherein said plurality of images include photographed images.

30. The apparatus of claim 27, wherein the plurality of images include line drawings.
